(19) United States
(12) Patent Application Publication
(10) Pub. No.: US 2012/0062438 A1
(43) Pub. Date: Mar. 15, 2012

(54) ANTENNA APPARATUS

(76) Inventors: Masahiro TANABE, Kawasaki-shi (JP); Yasuharu Masuda, Kawasaki-shi (JP)

(21) Appl. No.: 13/192,720

(22) Filed: Jul. 28, 2011

(30) Foreign Application Priority Data
Sep. 9, 2010 (JP) 2010-202091

(51) Int. Cl. H01Q 19/10

(52) U.S. Cl. 343/834

(57) ABSTRACT

According to one embodiment, an antenna apparatus includes an antenna element formed into a spiral shape, a sheet-shaped magnetic material arranged in tight contact with a back surface of the antenna element, and a reflector arranged with an air gap to the magnetic material.

### CROSS-REFERENCE TO RELATED APPLICATIONS

This application is based upon and claims the benefit of priority from prior Japanese Patent Application No. 2010-202091, filed Sep. 9, 2010, the entire contents of which are incorporated herein by reference.

### FIELD

Embodiments described herein relate generally to an antenna apparatus having wideband characteristics.

### BACKGROUND

A spiral antenna that radiates a wave only to the front is known to load an electromagnetic wave absorption material in the space between the antenna element and the cavity so as to realize wideband characteristics and low-profile of the antenna. When the operation frequency lowers, adopting a lossy magnetic material also enables reduction in profile of the antenna. However, when a magnetic material is set with an air gap on the back surface of the spiral, the reduction in profile of the antenna can be realized only with a lossy material whose relative permittivity almost equals the relative permeability. The thickness at that time is an important factor (for example, see Faruk Erkmen, Chi-Chih Chen, and John L. Volakis, “UWB Magneto-Dielectric Ground Plane for Low-Profile Antenna Applications”, IEEE Antennas and Propagation Magazine, Vol. 50, No. 4, August 2008 (to be referred to as reference 1 hereinafter).

### BRIEF DESCRIPTION OF THE DRAWINGS

FIG. 1 is a perspective view showing the arrangement of an antenna apparatus according to the embodiment;

FIG. 2 is an exploded view of the antenna apparatus in FIG. 1;

FIG. 3A is a graph showing the gain characteristics of the antenna apparatus in FIG. 1;

FIG. 3B is a graph showing the axial ratio characteristics of the antenna apparatus in FIG. 1;

FIG. 4A is a graph showing the gain characteristics of a conventional antenna apparatus;

FIG. 4B is a graph showing the axial ratio characteristics of the conventional antenna apparatus;

FIG. 5A is a graph showing the gain characteristics of a conventional antenna apparatus;

FIG. 5B is a graph showing the axial ratio characteristics of the conventional antenna apparatus;

FIG. 6 is a view showing the arrangement of an antenna apparatus according to the first modification;

FIG. 7 is a view showing the arrangement of an antenna apparatus according to the second modification;

FIG. 8 is a view showing the arrangement of an antenna apparatus according to the third modification; and

FIG. 9 is a view showing the arrangement of an antenna apparatus according to the fourth modification.

### DETAILED DESCRIPTION

In general, according to one embodiment, an antenna apparatus includes an antenna element formed into a spiral shape, a sheet-shaped magnetic material arranged in tight contact with a back surface of the antenna element, and a reflector arranged with an air gap to the magnetic material.

An antenna apparatus according to the embodiment will now be described with reference to the accompanying drawings.

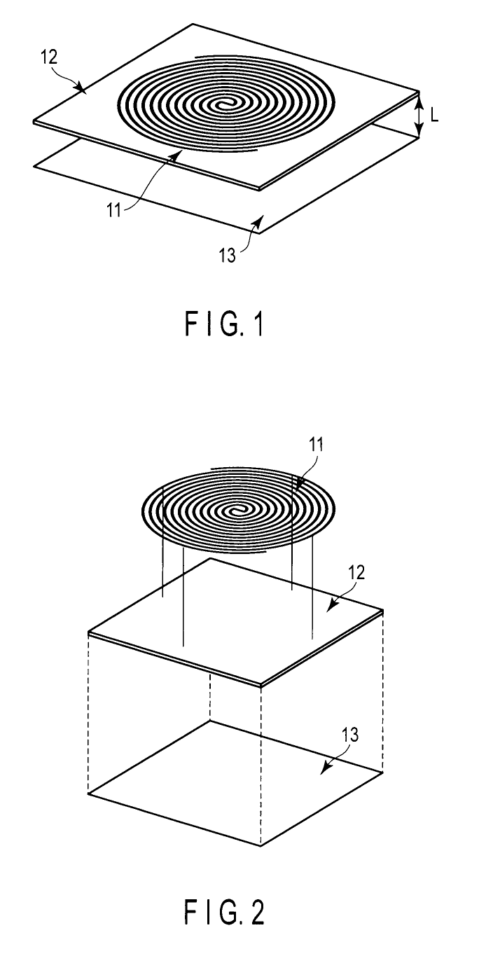

FIG. 1 is a perspective view of the antenna apparatus according to the embodiment. FIG. 2 is an exploded view of the antenna apparatus in FIG. 1.

This antenna apparatus comprises a spiral antenna 11, a magnetic sheet 12 arranged in tight contact with the back surface of the spiral antenna 11, and a metal conductor (reflector) 13 arranged with an air gap L to the magnetic sheet 12.

The operation of the spiral antenna having the above-described arrangement will be described next.

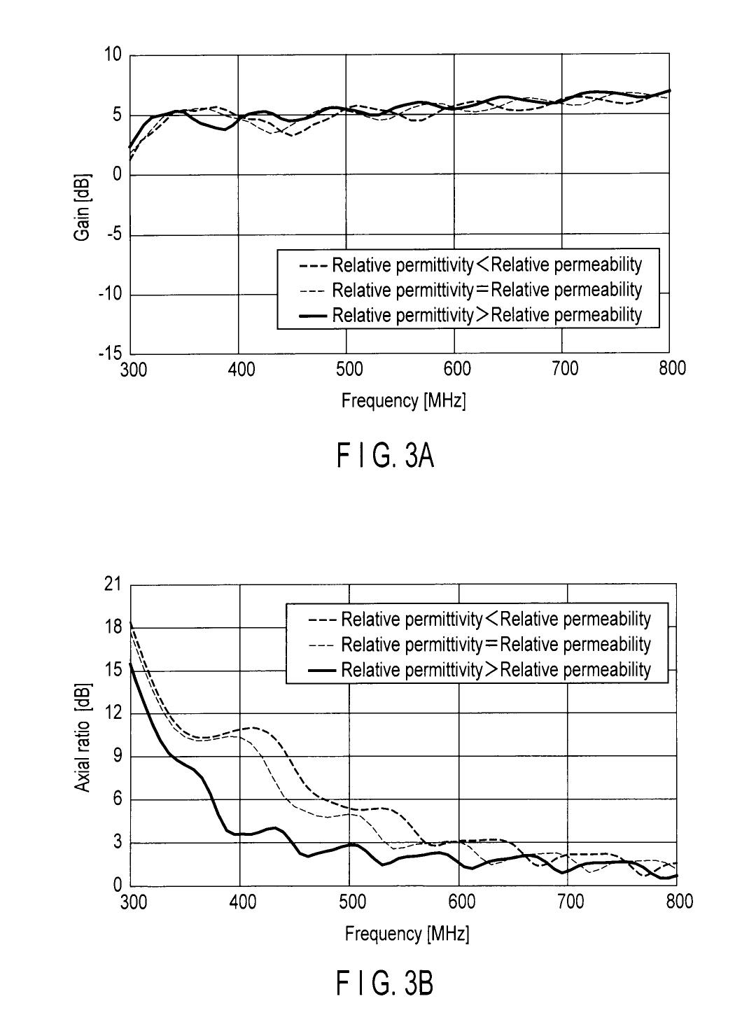

FIGS. 3A and 3B show the calculation results of the gain and axial ratio of the antenna apparatus shown in FIG. 1. In FIG. 3A, the abscissa represents the frequency in MHz, and the ordinate represents the gain in dB. In FIG. 3B, the abscissa represents the frequency in MHz, and the ordinate represents the axial ratio in dB. Referring to FIGS. 3A and 3B, the thick broken line indicates a case in which the relative permittivity is higher than the relative permeability. The thin broken line indicates a case in which the relative permittivity equals the relative permeability. The solid line indicates a case in which the relative permittivity is lower than the relative permeability.

The operation principle of the spiral antenna can be explained by the current band theory. More specifically, radiation from the antenna occurs in the region where the wavelength corresponding to the operating frequency equals the outer circumference of the antenna. Hence, when the outermost circumference of the spiral antenna is smaller than one wavelength circumference at the lowest operating frequency, radiation from the spiral antenna does not occur at that frequency. The current flowing in the spiral arm is reflected by the end of the spiral antenna, resulting in degradation of the antenna characteristics. As a technique of suppressing the reflected wave, an absorber is laid between the spiral antenna and the cavity so that the loss component of the electromagnetic wave absorption material contributes to suppressing the reflected wave. This allows the axial ratio characteristics to be improved. However, improvement of the axial ratio characteristics is difficult, if not impossible, because the gain characteristics depend on the thickness of the antenna.

To reduce the profile of an antenna whose frequency is lower than 1 GHz, using a magnetic material is also effective. In that case, the reduction in profile of the antenna is presumed to be possible when loading only a lossy magnetic material whose relative permittivity almost equals the relative permeability. However, to obtain satisfactory performance, the magnetic material needs to be thick. For this reason, although the antenna can be made smaller and thinner, a problem arises from the viewpoint of antenna weight reduction because the magnetic material is essentially heavy.

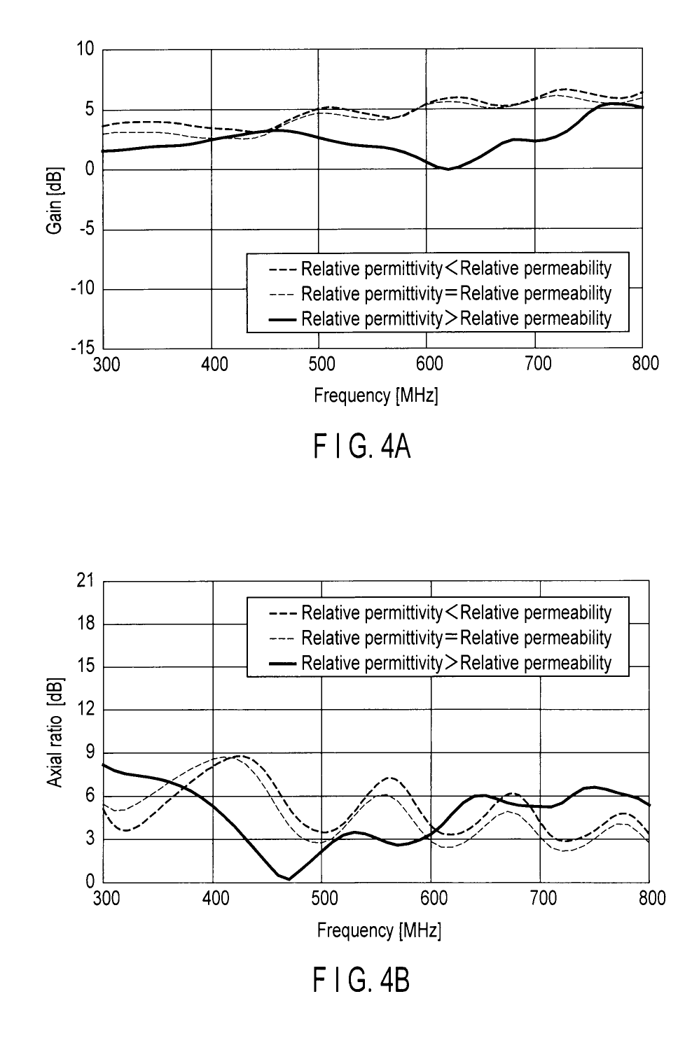

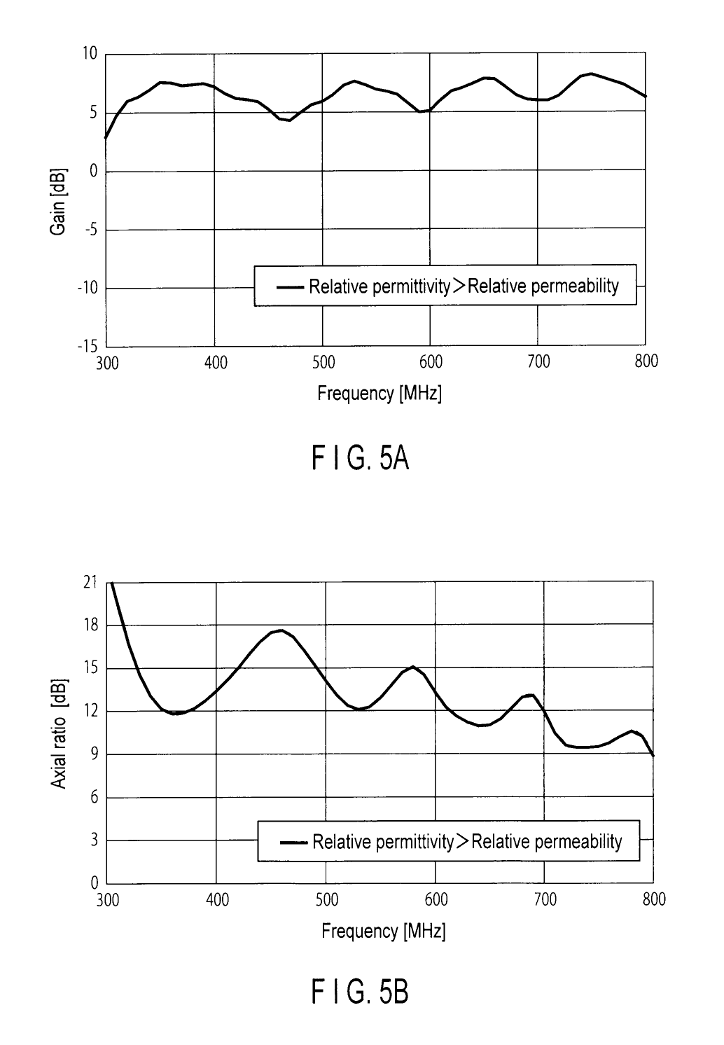

FIGS. 4A and 4B show examples of the calculation results of the gain and axial ratio of the antenna apparatus that loads a magnetic material having a thickness shown in reference 1. The gain calculation result shown in FIG. 4A reveals that satisfactory performance can be obtained when the relative permittivity equals the relative permeability. In this example, a relatively fine result is obtained even when the relative permittivity is lower than the relative permeability. As for the axial ratio characteristics in FIG. 4B, however, although a circularly polarized wave is generally radiated at 3 dB or less, the antenna that should radiate a circularly polarized wave does not do so. The technique of reference 1 originally reduces the influence of the reflected wave from the reflector upon reduction in profile of the antenna and thus improves the gain. This reflected wave rotates in the direction opposite to that of the original polarized wave of the antenna. Hence, the axial ratio cannot improve unless the reflected wave is further suppressed. To improve the axial ratio, the loss of the magnetic material is increased, or the magnetic material is made thicker. However, this poses a problem for the weight reduction of the antenna. When the magnetic material is made thinner ( 1/64 the thickness in reference 1) in this arrangement, not only the axial ratio characteristics but also the antenna gain has the frequency characteristics, resulting in considerable degradation in performance, as shown in FIGS. 5A and 5B.

In contrast, in the antenna apparatus of this embodiment, a thin magnetic material which has a magnetic loss and whose relative permittivity and relative permeability have values to some extent is arranged in tight contact with the back surface of the spiral antenna. This arrangement allows the gain and axial ratio characteristics to be improved, as shown in FIGS. 3A and 3B. Referring to FIG. 3A, for the antenna gain, a fine result is obtained independently of the relationship in magnitude between the relative permittivity and the relative permeability. As is apparent from FIG. 3B, the circularly polarized wave is radiated in a broader frequency band, as compared to the values shown in FIG. 5B, although the performance by the axial ratio also changes depending on the relationship in magnitude between the relative permittivity and the relative permeability. Since the wavelength shortening effect by the relative permittivity and the relative permeability is used, the same effect can be obtained with any material whose square root of the product of the relative permittivity and the relative permeability is large. Hence, in this embodiment, the condition that the relative permittivity almost matches the relative permeability, as in reference 1, is not essential. In addition, the antenna apparatus of this embodiment can employ extremely thin magnetic material, in contrast to a conventional antenna apparatus, and can therefore realize consequent weight reduction.

Note that the embodiment is not limited to that described above, and the following modifications, for example, can also be considered.

### First Modification

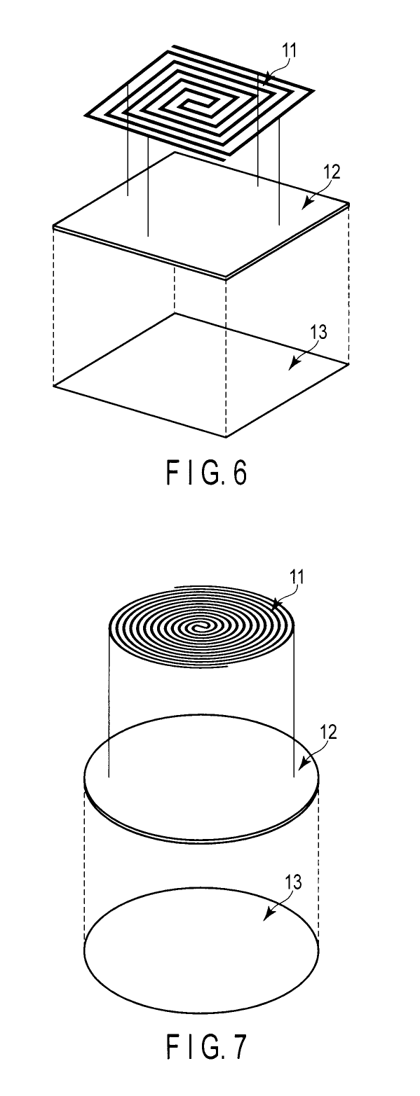

FIG. 6 shows the arrangement of the first modification. In the above-described embodiment, the spiral antenna is circular. However, the shape need not always be circular. A spiral antenna having a polygonal shape such as a square as shown in FIG. 6 can also obtain the same effect. In addition, the same effect as in the above embodiment can be obtained using a single point feed spiral antenna as the antenna element.

### Second Modification

FIG. 7 shows the arrangement of the second modification. The same effect as in the above embodiment can be obtained even when the magnetic sheet 12 mounted is circular, as shown in FIG. 7, or annular or polygonal.

### Third Modification

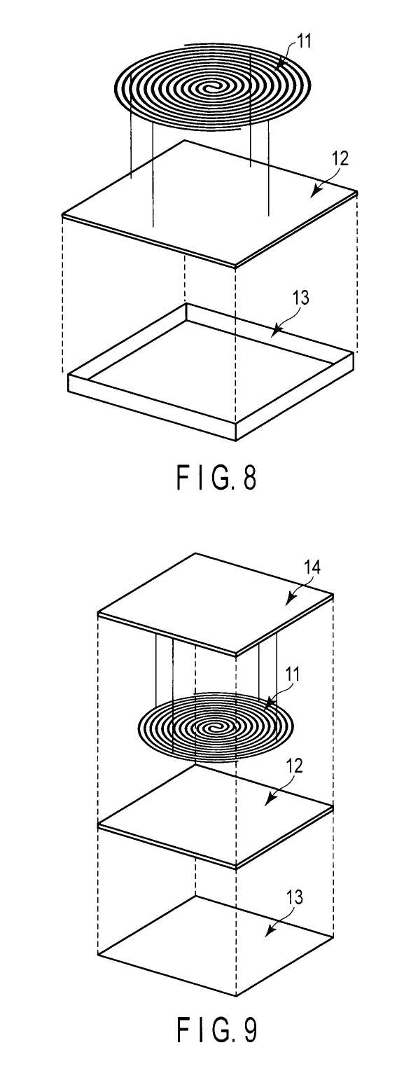

FIG. 8 shows the arrangement of the third modification. The same effect as in the above embodiment can be obtained even when the reflector 13 mounted on the back surface has a cavity, as shown in FIG. 8.

### Fourth Modification

FIG. 9 shows the arrangement of the fourth modification. The thin magnetic material 12 is actually difficult to erect. It is therefore necessary to add a dielectric 14 to the front surface of the spiral antenna 11, as shown in FIG. 9. In this case as well, the same characteristics as in the above embodiment can be obtained as antenna performance.

Additionally, the same effect as described above can be obtained by combining the first to fourth modifications.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An antenna apparatus comprising:
an antenna element formed into a spiral shape;
a sheet-shaped magnetic material arranged in tight contact with a back surface of the antenna element; and
a reflector arranged with an air gap to the magnetic material.

2. The apparatus according to claim 1, wherein the antenna element is formed into one of a circular spiral shape and a polygonal spiral shape.

3. The apparatus according to claim 1, wherein the magnetic material is formed into one of a circular shape, an annular shape, and a polygonal shape.

4. The apparatus according to claim 1, wherein the reflector has a cavity.

5. The apparatus according to claim 1, further comprising a dielectric on an upper surface of the antenna element.
